(19) United States
(12) Patent Application Publication
(10) Pub. No.: US 2005/0230874 A1
(43) Pub. Date: Oct. 20, 2005

(54) Method for making thread

(75) Inventors: Chang-Hong Liu, Beijing (CN); Hua Huang, Beijing (CN); Shou-Shan Fan, Beijing (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignees: Tsinghua University, Beijing City (CN); HON HAI Precision Industry Co., LTD., Tu-Cheng City (TW)

(21) Appl. No.: 11/049,066

(22) Filed: Feb. 1, 2005

(30) Foreign Application Priority Data
Apr. 15, 2004 (CN) 200410026918X

(51) Int. Cl. B29C 67/00

(52) U.S. Cl. 264/164

(57) ABSTRACT

A method (10) for making a thread includes the steps of: mixing a polymer material and a solvent to form a solution (11); providing a liquid containing polar molecules, the liquid being insoluble in the solution (12); adding the solution to the liquid to form a solution film on a surface of the liquid (13); and applying an apparatus having a tip to the solution film for drawing out a thread therefrom (14). The solution can further contain an additive for improving one or more properties of the thread. The additive can be selected from nano-materials, for example, carbon nanotubes. The liquid containing polar molecules is water, or a solution having water as a solvent. The tip of the apparatus is needle-shaped.

### BACKGROUND OF THE INVENTION

1. Field of the Invention

The present invention relates to a method for making a thread, and more particularly to a method for making a microthread of polymer material.

2. Description of Related Art

Microthreads of polymer material have for many years been made by a hot-air spin-blowing method, which is also known as the melt-blowing method. Today there are different apparatuses for making the microtbreads. A common feature of all of the apparatuses is that they have parallel rows of spinning holes, and hot air escaping from the holes for drawing the threads or fibers. The holes may be as small as 0.25 mm in diameter, and adjacent holes are spaced apart a distance less than 0.6 mm. The threads or fibers are cooled and solidified by exposing them to ambient air.

One disadvantage of the melt-blowing method is the high expenditure of energy to heat the hot air flowing at high speed. In addition, the sizes and spacings of the individual spinning holes limit throughput. Furthermore, more to the high air temperature necessary to produce fine threads, the polymers are easily thermally damaged. During processing, the threads are liable to break and have a finite length. Moreover, the spinning nozzle of a typical apparatus is inherently problematic. The spinning nozzle may be any of various kinds known in the art. Nevertheless, a typical spinning nozzle is an elaborate injection molding die, which must be made with high precision. Even so, it is generally difficult to accurately control the diameter of the thread produced. In summary, the spinning nozzle is expensive and has limited efficacy.

Several additives can be incorporated into the polymer material to improve the properties of the thread. For example, carbon nanotubes can be added. However, the above-described melt-blowing method cannot make the carbon nanotubes distribute directionally. As a result, the additives may provide little or even no improvement to the properties of the thread.

### SUMMARY OF THE INVENTION

In view of the above-described shortcomings, an object of the present invention is to provide a simple and low cost method for making a continuous thread, in which a diameter of the thread is easy to control.

In order to achieve the object set out above, a method for making a thread in accordance with the present invention comprises the steps of mixing a polymer material and a solvent to form a solution; providing a liquid containing polar molecules, the liquid being insoluble in the solution; adding the solution to the liquid to form a solution film on a surface of the liquid; and applying an apparatus having a tip to the solution film for drawing out a thread therefrom.

Preferably, the solution further contains at least one additive for improving one or more properties of the thread. The at least one additive can be selected from a variety of nano-materials, and may for example be carbon nanotubes. The liquid containing polar molecules is water, or a solution having water as a solvent. The solvent is ethyl acetate, and the polymer material is polyurethane. The tip of the apparatus is needle-shaped.

The method may further comprise the step of solidifying the thread and/or collecting the thread after drawing the thread out from the solution film.

In summary, the liquid containing polar molecules is used as a carrier for the solution having the polymer material and solvent. Because of effects of the polar molecules and surface tension of the liquid, the solution quickly forms a uniform thin film on a surface of the liquid. Thereby, a stickiness of molecules in the thin film is enhanced, and a thread having high uniformity and continuity can be drawn out from the thin film by the tip of the drawing apparatus. A diameter and length of the thread are easy to control. In addition, the method can be performed easily without the need for large, expensive machines.

Moreover, in the case where the solution contains one or more additives, molecules of the additives are uniformly distributed throughout the thin film when the thin film is formed. The manufactured thread thus has improved and stable properties.

These and other features, aspects and advantages of the invention will become more apparent from the following detailed description, claims, and the accompanying drawing.

### BRIEF DESCRIPTION OF THE DRAWING

FIG. 1 is a flowchart of a method for making a thread in accordance with the present invention.

### DETAILED DESCRIPTION OF THE PREFERRED EMBODIMENT OF THE PRESENT INVENTION

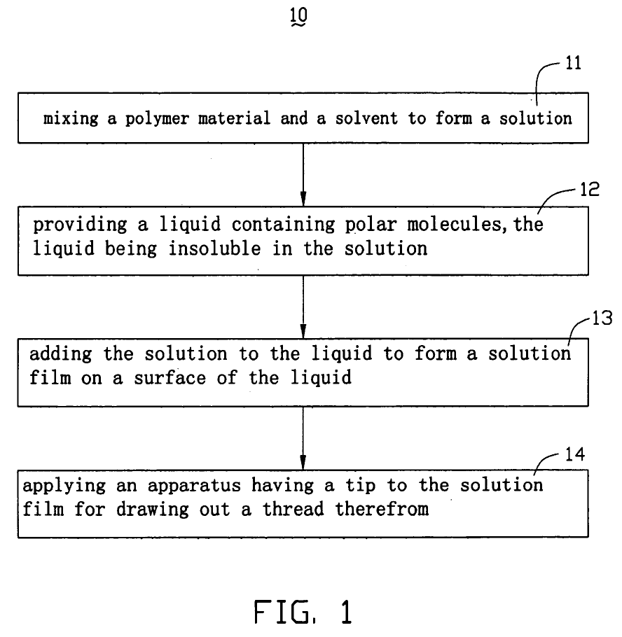

With reference to FIG. 1, a method 10 for making a thread in accordance with the present invention comprises the steps of:

step 11, mixing a polymer material and a solvent to form a solution;

step 12, providing a liquid containing polar molecules (hereinafter “the liquid”) as a medium, the liquid being insoluble in the solution;

step 13, adding the solution to the liquid to form a solution film on a surface of the liquid; and,

step 14, applying a drawing device having a tip to the solution film for drawing out a thread therefrom.

In step 11, the polymer material is preferably polyurethane. The solvent dissolves the polymer material, such that polymer molecules of the polymer material are distributed uniformly therein. The polymer molecules include, for example, ethyl acetate. Furthermore, one or more additives can be incorporated into the solution for improving the properties of the thread. The additives can be selected from a range of nano-materials, such as carbon nanotubes, carbon nano-capsules, and the like. The additives are distributed uniformly in the solution by an ultrasonic resonator.

In step 12, a density of the liquid is higher than that of the solution containing the polymer molecules. Thus, the liquid carries the solution. Preferably, the polar molecules are water molecules (H₂O). Therefore the liquid can be water or a solution having water as a solvent. The liquid is placed in a container having a broad opening. Accordingly, the liquid has a large exposed surface area.

In the step 13, because of effects of the polar molecules and surface tension of the liquid, the solution quickly forms a uniform thin film on the surface of the liquid.

In the step 14, the tip of the drawing device is preferably needle-shaped. It should be noted that a diameter of the thread depends on the constituents and a quantity of the solution added to the liquid, a diameter of the tip of the drawing device, and a speed of drawing of the thread. The above variables can be adjusted in order to manufacture a thread having a desired diameter.

It will be understood by those skilled in the art that a continuous thread can be manufactured by drawing the thread mechanically and constantly adding the solution to the liquid. A plurality of threads can likewise be manufactured by employing a plurality of tips. Furthermore, the method 10 can comprise the additional step of solidifying the thread or collecting the thread after step 14.

### EXAMPLE

Six drops of polyurethane (about 0.2 ml) are added into a beaker containing 20 ml of ethyl acetate. 2 mg of carbon nanotubes, as an additive, are also added into the beaker to form a solution. The beaker having the solution is put into a KQ-500B type of ultrasonic cleaning machine for five minutes to make the molecules distribute uniformly in the solution. Afterward, the solution is drawn into a medical syringe, and then 6-10 drops (about 0.2-0.3 ml) of the solution are deposited onto a stainless steel plate containing deionized water. The deionized water has a temperature of about thirty degrees Celsius. After 20-30 seconds, a needle of the medical syringe is touched onto a surface of the solution and lifted back up. Thereby, a thread is drawn out from the solution. The thread is coiled onto a spool driven by a stepping motor, at a drawing speed of about 12 cm/sec. The obtained thread has a diameter of about 1 micron.

In summary, the liquid containing polar molecules is used as a carrier for the solution having the polymer material and solvent. Because of the effects of the polar molecules and surface tension of the liquid, the solution quickly forms a uniform thin film on the surface of the liquid. Thereby, a stickiness of molecules in the thin film is enhanced, and a thread having high uniformity and continuity can be drawn out from the thin film by the tip of the drawing apparatus. In the case where the solution contains one or more additives, molecules of the additives are uniformly distributed throughout the thin film when the thin film is formed. The manufactured thread thus has improved and stable properties. In addition, the method can be performed easily without the need for large, expensive machines.

Further, the diameter and a length of the thread are easy to control. Accordingly, the thread can be controlled to have a very small diameter, which facilitates directional alignment of the carbon nanotubes within the thread.

It should be understood by those skilled in the art that other appropriate polymer materials and additives can be applied in the method for making a thread in accordance with the present invention. Further, the solvent and the liquid are selected according to the particular polymer materials used, and the solvent and the liquid described above are not intended to limit the present invention.

Further, while the present invention has been described with reference to particular embodiments, the description is illustrative of the invention and is not to be construed as limiting the invention. Therefore, various modifications can be made to the preferred embodiments by those skilled in the art without departing from the true spirit and scope of the invention as defined by the appended claims.

1. A method for making a thread, comprising the steps of
mixing a polymer material and a solvent to form a solution;
providing a liquid containing polar molecules, the liquid being insoluble in the solution;
adding the solution to the liquid to form a solution film on a surface of the liquid;
and applying an apparatus having a tip to the solution film for drawing out a thread therefrom.

2. The method for making a thread as claimed in claim 1, wherein the solution further contains at least one additive for improving one or more properties of the thread, and the at least one additive is selected from nano-materials.

3. The method for making a thread as claimed in claim 2, wherein the at least one additive comprises carbon nanotubes and/or carbon nano-capsules.

4. The method for making a thread as claimed in claim 1, wherein the liquid containing polar molecules comprises water.

5. The method for making a thread as claimed in claim 1, wherein the solvent is ethyl acetate.

6. The method for making a thread as claimed in claim 1, wherein the polymer material is polyurethane.

7. The method for making a thread as claimed in claim 1, further comprising the step of solidifying the thread after drawing the thread out from the solution film.

8. The method for making a thread as claimed in claim 1, further comprising the step of collecting the thread after drawing the thread out from the solution film.

9. The method for making a tread as claimed in claim 1, wherein the tip of the apparatus is needle-shaped.

10. A method for making a thread, comprising the steps of
forming a solution of a polymer material;
providing a liquid being insoluble in the solution and having a density higher than that of the solution;
adding the solution to the liquid to form a solution film on a surface of the liquid;
and drawing out a thread from the solution film by using an apparatus having a tip.

11. A method for making a thread, comprising the steps of:
providing a solution of material used to form said thread;
providing a medium insoluble from said solution of said material;
dropping a bit of said solution of said material onto said medium to form a film of said solution on said medium;
and drawing said thread from said film of said solution with help of said medium.

12. The method as claimed in claim 11, wherein said medium is composed of polar molecules and said material is composed of non-polar molecules.

13. The method as claimed in claim 11, wherein said medium is water and said material is polyurethane.

14. The method as claimed in claim 11, wherein a needle-shaped apparatus is used to draw said thread by means of dipping into said medium before drawing in said drawing step.

15. The method as claimed in claim 11, further comprising the step of mixing uniformly at least one additive in said solution.
